(19) United States
(12) Patent Application Publication
(10) Pub. No.: US 2010/0293141 A1
(43) Pub. Date: Nov. 18, 2010

(54) Method and a System for Obtaining Differential Backup

(76) Inventors: Pankaj Anand, Haryana (IN); Nitin Arora, Haryana (IN); Puneet Trehan, Haryana (IN); Rakesh Sharrma, Haryana (IN); Aniruddha Chaudhuri, Cupertino, CA (US); Pankaj Sharma, Haryana (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/294,938

(22) PCT Filed: May 31, 2007
(86) PCT No.: PCT/IB2007/001423

§ 371 Date: Jul. 26, 2010

(30) Foreign Application Priority Data
May 31, 2006 (IN) 1316/DEL/2006

(51) Int. Cl. G06F 17/30

(52) U.S. Cl. 707/640; 707/693; 707/E17.007; 707/697

(57) ABSTRACT

The present invention provides a method that uses differential backup which is a key feature when uploading file for back up data from a client terminal to a server terminal. At the time of backup, only the changes from the client terminal side are sent back to the server terminal which saves the bandwidth and makes the process fast. While uploading, data is sent in the form of chunks of fixed size. In case any of the chunks could not be delivered on the server terminal, the same chunk is retransmitted from the client terminal.

### FIELD OF THE INVENTION

The present invention relates to a method and a system for obtaining differential backup. The method of differential backup disclosed in the present invention solves the major obstacle of an internet based backup solution wherein bandwidth can be a major bottleneck.

### BACKGROUND AND PRIOR ART DESCRIPTION

There is an increasing demand of storing files in a secure and robust manner on the files storage servers. The process of storing the files on demand upon the files storage servers is known as “taking backup”. The files storage server is also commonly referred to as backup server.

For example, in order to avoid loss of an important file, the file is stored on the server the file, the file is stored upon a backup server. It should be noted that any type of file, such as files including text or data which created by the user or files including software codes etc can be backed up.

Hereinafter the term “old version” or “original version” refers to content before update, the term “new version” or “updated version” refers to the content after it was updated. The terms “recipe file” or “update package” or “difference” or “difference result” includes data provided as input for an update process, wherein the update process updates the old version to the new version in accordance with the update package.

Currently the process of taking backup of the data comprises storing the entire file in a single shot on a backup server. It is known to those versed in the art that content can be stored upon a backup server which serves as a storage device, wherein the storage device is organized in blocks. Blocks being part of the original version are referred to as “old blocks” or “original blocks”, while blocks being part of an updated version are referred to as “new blocks” or “updated blocks”.

In addition, when updating an original version forming an updated version thereby, the updated version can sometimes use content previously stored in blocks of the original version. That is, the content of updated blocks is sometimes similar to content of original blocks.

As the backup servers have a limited space, there is a constant need to store the data on the backup server in as much efficient manner as possible. One method which is commonly adopted to save the space is to store the new version in place of the old version at the time of saving the updating version, thereby saving space. Such an update process, is referred to, in the art as “in-place backup” or “backing up in-place”. One of the outcomes of in-place backup is that once the updated version is stored, the old version is deleted and its contents are completely lost. However, it is known in the art that the old content is sometimes required.

In addition, as the backup server is separated from the terminal whose data is being backed up, a communication link must be provided to enable the backup process to proceed. In a backup in-place method, the communication link is occupied for a longer time period.

There is a need in the art for faster, reliable, less backup space consuming backup procedures that allow less utilization of the communication link during the entire backup procedure.

### OBJECTS OF THE PRESENT INVENTION

It is an object of the present invention, at least in the preferred embodiments, to overcome or ameliorate at least one of the disadvantages of the prior art, or to provide a useful alternative method of storing files in a faster or reliable or less backup server space consuming manner.

It is another object of the present invention, at least in the preferred embodiments, to overcome or ameliorate at least one of the disadvantages of the prior art, or to provide a useful alternative method of storing files on a backup server that utilization of the communication link.

### SUMMARY OF THE INVENTION

Accordingly, the present invention relates to a method that uses differential backup which is a key feature when uploading file for back up data from a client terminal to a server terminal. At the time of backup, only the changes from the client terminal side are sent back to the server terminal which saves the bandwidth and makes the process fast. While uploading, data is sent in the form of chunks of fixed size. In case any of the chunks could not be delivered on the server terminal, the same chunk is retransmitted from the client terminal.

### DETAILED DESCRIPTION OF THE INVENTION

Accordingly, the present invention provides a method for taking differential backup of a file present at a client terminal, said method comprising the steps of:
(a) receiving the file to be backed-up from the client terminal;
(b) determining presence of an entry corresponding to the file thus received at a client repository; characterized in that:
(c) if the client repository does not contain an entry corresponding to the file, the method comprising the sub-steps of:
   i. compressing the file thus received in step (a),
   ii. updating the client repository to create an entry of the file, and
   iii. transmitting the file thus received in step (a) and/or the compressed file thus generated in step (i) to a remote location; or
(d) if the client repository contains an entry corresponding to the file, the method comprising the sub-steps of:
   i. generating a recipe file using longest common subsequence method,
   ii. updating the client repository to create an entry of the recipe file, and
   iii. transmitting the recipe file to the remote location.

In an embodiment of the present invention, steps (a) to (d) are performed at the client terminal.

In another embodiment of the present invention, the file compressed in sub-step (i) of step (c) is stored at the client terminal.

In yet another embodiment of the present invention, in sub-step (iii) of step (c), the file received in step (a) is transmitted to the remote location.

In still another embodiment of the present invention, after transmitting the file received in step (a), step (c) optionally comprises the step of deleting the file thus received in step (a) from the client terminal.

In one more embodiment of the present invention, the recipe file generated in sub-step (i) of step (d) is optionally in a compressed form.

In a further embodiment of the present invention, after transmitting the compressed form of the recipe file, step (d) optionally comprises the step of deleting the recipe file thus generated from the client terminal.

The present invention further provides a method for taking differential backup of a file present at a client terminal upon a server terminal, said method comprising the steps of:
(a) receiving detail of the file to be backed-up from the client terminal;
(b) determining presence of an entry corresponding to the file details thus received from the client terminal at a server repository; characterized in that:
(c) if the server repository does not contain an entry corresponding to the file details, the method comprising the sub-steps of:
   i. receiving the file from the client terminal,
   ii. storing the file thus received at the server terminal; and
   iii. updating the server repository to create an entry of the file, or
(d) if the server repository contains an entry corresponding to the file details, the method comprising the sub-steps of:
   i. receiving at least one client check sum from the client terminal;
   ii. comparing each of the at least one client check sum with corresponding at least one server check sum to generate mismatched check sum; and
   iii. in respect of each mismatched check sum, receiving a client chunk from the client terminal, storing the client chunk(s) thus received at the server terminal and updating the server repository to create entry(ies) of the client chunk(s) thus stored.

In an embodiment of the present invention, steps (a) to (d) are performed at the server terminal.

In another embodiment of the present invention, the file thus received from the client terminal in sub-step (i) of step (c) is optionally in a compressed form.

In yet another embodiment of the present invention, the client check sum is generated by breaking the file to be backed up present at the client terminal into plurality of client chunks and calculating client check sum in respect of each client chunk.

In still another embodiment of the present invention, the server check sum is generated by breaking the file present at the server terminal into plurality of server chunks and calculating server client check sum in respect of each server chunk.

In one more embodiment of the present invention, the file which is broken is in un-compressed form.

In one another embodiment of the present invention, if any client chunk is received by the server in sub-step (iii) of step (d), the method optionally comprises generating a recipe file using longest common subsequence method.

In a further embodiment of the present invention, a recipe file is generated based on a client chunk and its corresponding server chunk.

In a further more embodiment of the present invention, the recipe file thus generated is stored at the server terminal.

In another embodiment of the present invention, after generation of the recipe file, the client chunk and its corresponding server chunk are re-arranged to facilitate further processing.

### BRIEF DESCRIPTION OF THE ACCOMPANYING DRAWINGS

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 illustrates the flow chart of the method performed at the user terminal for taking the differential backup.

FIG. 2 illustrates the flow chart of the method performed at the server terminal for taking the differential backup

FIG. 3 illustrates the block diagram of the system which performs the method of the present invention.

The following paragraphs are provided in order to describe the working of the invention and nothing in this section should be taken as a limitation of the claims.

### DETAILED DESCRIPTION OF THE EMBODIMENTS

Before describing in detail embodiments that are in accordance with the present invention, it should be observed that the embodiments reside primarily in combinations of method steps of taking backup such that the backup procedure is faster, less bandwidth consuming and at the same time reliable.

Accordingly, the method steps have been represented where appropriate by conventional symbols in the drawings, showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a process, method that comprises a list of steps does not include only those steps but may include other steps not expressly listed or inherent to such process, method. An element proceeded by “comprises . . . a” does not, without more constraints, preclude the existence of additional identical steps in the process or method that comprises the steps.

For the sake of simplicity of understanding, the invention is classified into two categories, the first relating to the method steps that would be performed at the client terminal from where the data to be backed up is provided and the second relating to the method steps that would be performed at the server terminal where the data is backed up.

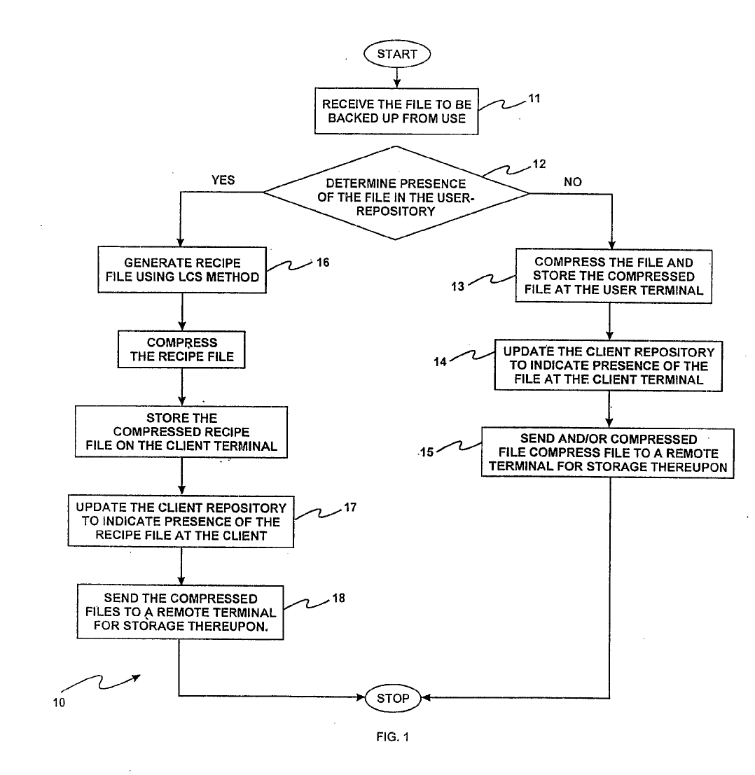

FIG. 1 illustrates the flow chart (10) of the method steps that are performed at the user terminal for taking the differential backup. The steps involved in taking differential backup which are performed at the client terminal include: receiving the file to be backed-up from the client terminal (11) and determining presence of an entry corresponding to the file thus received at a client repository (12). It should be noticed that there are three different types of situations which are basically grouped in such a manner that the three different types of situations fall in either of a first category or a second category. The three different situations include:
(a) the file did not previously exist on the client terminal and has been newly created;
(b) the file existed on the client but has not been backed up by the user till date; and
(c) the file existed on the client terminal and has been backed up at least once by the user.

The first and the second situations i.e. situations outlined in (a) and (b) are grouped together in a single category which corresponds to the situation wherein the client repository does not contain an entry corresponding to the file. On the other hand, the third situation i.e. the situation outlined in (c) is categorized in the second category which corresponds to the situation wherein the client repository would contain an entry corresponding to the file.

If the client repository does not contain an entry corresponding to the file, the file is considered as “old version” or “original version” and the process of taking differential backup comprises the sub-steps of: compressing the original version file thus received (13), updating the client repository to create an entry of the file (14), and transmitting the original version file and/or the compressed original version file to a remote location (15). The remote location here corresponds to the backup server.

On the other hand, if the client repository contains an entry corresponding to the file, the file is considered as “new version” or “updated version” and the process of taking differential backup comprises the sub-steps of: generating a “recipe file” using longest common subsequence method (16), updating the client repository to create an entry of the recipe file (17), and transmitting the recipe file to the remote location (18).

The client repository contains the files to be backed up on the server on the client side in compressed form. The repository also maintains the different version of the recipe of the same file also in a compressed form. The benefit of creating a repository is that the files could be retrieved if found on the client side instead of going to server.

There are certain features which the Applicants believe may prove to be beneficial or preferable to the user as compared to some of the other features. By way of example, the user may prefer that the file which has compressed in sub-step (i) of step (c) being stored at the client terminal (client terminal is the terminal upon which the user works). This may be because the compressed file would consume less space as compared to the un-compressed file. The user may prefer to store the un-compressed file at the backup server terminal or in other words, may prefer in step 15, to transmit the file received in step 11 to the remote location.

In another example, after performing step 15 and more particularly after transmitting after transmitting the file received in step 11 in step 15, the user may prefer to delete the file which was received in step 11 from the client terminal in totality. Thus, in such instances, the method of taking differential backup may further comprise the step of deleting the file received in step 11 from the client terminal. This may seem logical because it may not be necessary to store both the compressed and the un-compressed file at the user terminal, also because of the reason that compression/un-compression software are now loaded in most of the user terminals such as lap tops.

In yet another example, the recipe file thus generated in sub-step 16 may be preferably in a compressed form. The recipe file can be preferably a binary or textual file which contains position and characters of difference between two versions of the same document. The recipe file is generated using Longest Common Subsequence method.

Now if we look at the entry contained by client repository, the client repository contains details of the compressed backed up files. It may in addition contain file rank and check sum allocated to one or more of the files contained in the client repository.

A checksum is a form of redundancy check, a simple way to protect the integrity of data by detecting errors in data that are sent through space (telecommunications) or time (storage). It works by adding up the basic components of a message, typically the asserted bits, and storing the resulting value. Anyone can later perform the same operation on the data, compare the result to the authentic checksum and (assuming that the sums match) conclude that the message was probably not corrupted. The checksum used in this invention is Cyclic Redundancy Check (CRC) which is a powerful method for detecting errors in the received data is by grouping the bytes of data into a block and calculating a Cyclic Redundancy Check (CRC). For further information please refer http://tools.ietf.org/html/rfc3385.

Rank of a file is the points which are allocated to a file on the basis of its characteristics like File Size, File Type and Last Write Time, wherein file size refers to the length of the file on disk, file type refers to the nature of the content of the file like text, image, binary etc. and last write time refers to the data and time when the file was last modified.

The method of the present invention uses differential backup which is a key feature when uploading file for back up data from a client terminal to a server terminal. At the time of backup, only the changes from the client terminal side are sent back to the server terminal which saves the bandwidth and makes the process fast. While uploading, data is sent in the form of chunks of fixed size. In case any of the chunks could not be delivered on the server terminal, the same chunk is retransmitted from the client terminal.

By way of example, rank may be calculated on the basis of the file size, file type and the last write time. Rank of a file denotes the importance of a file in the client repository. Rank is an integer based value and can be calculated by the following formula:

Rank=(Weight of Size Rank)*Size Rank+(Weight of Type Rank)*Type Rank+(Weight of LastWriteTime Rank)*LastWriteTime Rank

Weights of the Size Rank, Weight of Type Rank and Weight of LastWriteTime Rank are static integer values which denote the importance of each type of rank in overall rank of the file. E.g. the same size and type of the file which is modified recently will have a higher rank than the same size and type of the file modified a day ago.

Weight for Size Rank, Weight of Type Rank and Weight of LastWriteTime Rank for example can be allocated as 2, 4 and 2 respectively. These figures have been calculated on the basis of research done on various user data and usage patterns.

### Size Rank

Size Rank is calculated on the basis of the size slabs like 0-100 KB, 100-400 KB, 400-600, 600-1024 KB, and 1024 KB onwards. Here is a sample table for Size Rank calculation

| Size Range | |
|---|---|
| (KB) | Size Rank |
| 100-400 | 5 |
| 400-600 | 7 |
| 600-1024 | 10 |
| 1024> | 15 |

The significance of size rank is that if a file is smaller in size, it is not advisable to differentially back it up because in such cases the recipe of smaller files exceeds the original file size. Hence for optimization purpose, smaller files have a lower rank than larger files. Moreover if the file is large it should be stored in the client repository because backing up that file differentially will save a lot of network bandwidth.

### Type Rank

Type Rank is calculated on the basis of category of file types. Documents like Microsoft Office Word, presentations, tabular data files and text files have higher chances of modification where as picture, music and video files have a minor chance of modification. Hence, picture, video and music files have a very lower rank.

### Last Write Time Rank

Last write time rank is calculated on the basis of the number of hours elapsed since an old date time value like Jan. 1, 1990, 12:00:00. This rank signifies that the files which are frequently modified must take precedence over files which are hardly being modified. The client repository automatically updates the Last Time Rank according to the usage pattern of the user. E.g. if a file was modified at time T1 and T2 (T2 being recent) then the LastWriteTimeRank (T1)<LastWriteTimeRank(T2). This follows the fundamental of least recently used (LRU) files.

### Client Terminal and Client Repository Management

Client terminal maintains the compressed of backed up files and client repository maintains an index of the backed up files. The client terminal and/or the client repository may have an upper limit on the size. According to our usage pattern research, it is believed that a user frequently modifies about 20% of its entire data on the computer. The optimum value of the client repository size should be 20% of the entire data captured for backup. The file ranks are automatically calculated at the time of insertion in the client repository or modification of a file. Every time a file is backed up, the file rank is calculated. If the rank is a non-zero value, the file is inserted in the client repository. If the client repository is full i.e. approaching the maximum size limit, then the backed up file is only inserted if the rank of that file is higher than the lowest rank in the client repository. If so, the lowest ranked file or files are deleted from the client repository to accommodate the new file in the client repository.

Here is a sample client repository snapshot for illustration:

| FileID | Checksum | Rank |
|---|---|---|
| {5B62B17F-A98A-4408-B158- | 3D603FC5 | 6 |
| B9E24CB8E822} | | |
| {A559844F-F353-4c01-8E1B- | 63ABAA43 | 6 |
| 43BE2020F4B1} | | |
| {C5562301-F4CB-47fb-A37F- | 7E4583CC | 8 |
| 9E7C8F2AD4D9} | | |
| {FA55D1BB-65C0-44fl-9801- | 9B9EFBA5 | 9 |
| 2C1987228EDA} | | |
| {DCBCE2A3-9D37-4989-A00A- | 37C8A8C4 | 11 |
| 4D94C183966F} | | |
| {C1EAC278-B686-4b23-BCCE- | 5AC73C66 | 11 |
| C86BB43946CC} | | |
| {9D89E4DE-F734-4d71-A43D- | 028C72D9 | 15 |
| 95B77547849A} | | |
| {621120F4-4315-437a-AFC8- | 6AE2809C | 34 |
| FE282E321C9B} | | |
| {69F82FB3-8AEC-4abe-80D4- | CFC459EB | 43 |
| 23A12DC671E6} | | |
| {1E571D94-A6BF-4cde-B232- | 72CAF820 | 55 |
| F8E43640DCA7} | | |

Life time management and LCS calculation: The life time management is a key feature which is present on the client side which manages the life time of the file of the client repository. It decides whether to keep the file or delete the file from the repository. If the old file is found inside the client repository then LCS is calculated on the client side only which generates the recipe.

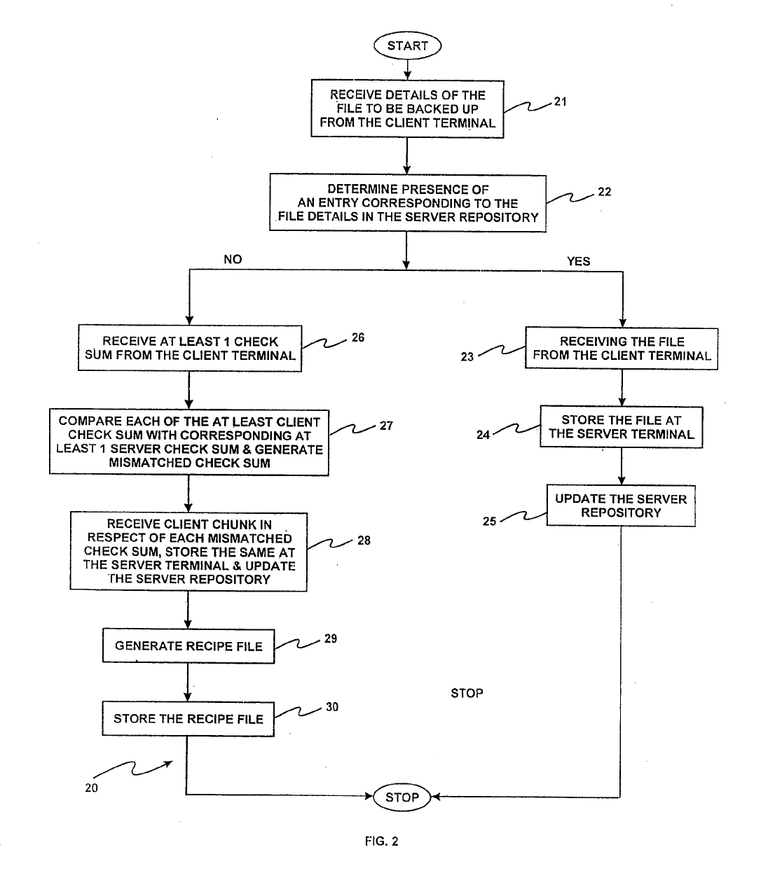

FIG. 2 illustrates the flow chart (20) of the method steps that are performed at the server terminal for taking the differential backup. The steps involved in taking differential backup of the files present at the user terminal which are performed at the server terminal include: receiving detail of the file to be backed-up from the client terminal (21) and determining presence of an entry corresponding to the file details thus received from the client terminal at a server repository (22).

If the server repository does not contain an entry corresponding to the file, the file is considered as “old version” or “original version” and the process of taking differential backup comprises the sub-steps of: receiving the file from the client terminal (23), storing the file thus received at the server terminal (24); and updating the server repository to create an entry of the file (25).

On the other hand, if the server repository contains an entry corresponding to the file, the file is considered as “new version” or “updated version” and the process of taking differential backup comprises the sub-steps of: receiving at least one client check sum from the client terminal (26); comparing each of the at least one client check sum with corresponding at least one server check sum to generate mismatched check sum (27); and in respect of each mismatched check sum, receiving a client chunk from the client terminal, storing the client chunk(s) thus received at the server terminal and updating the server repository to create entry(ies) of the client chunk(s) thus stored (28).

There are certain features which the Applicants believe may prove to be beneficial or preferable to the user as compared to some of the other features. By way of example, the file thus received from the client terminal in sub-step 23 is optionally in a compressed form.

In yet another preferred embodiment, instead of generating the check sum for the entire file, the file is first broken into plurality of chunks and thereafter check sum in respect of each of the chunk is determined. By way of example, the client check sum is generated by breaking the file to be backed up present at the client terminal into plurality of client chunks and calculating client check sum in respect of each client chunk. Similarly, the server check sum is generated by breaking the file present at the server terminal into plurality of server chunks and calculating server client check sum in respect of each server chunk. As breaking of the file is possible only if the file is in an un-compressed form, for breaking a compressed file, the file is firstly un-compressed and thereafter it is subjected to the breaking process.

Although the above described steps in themselves are sufficient to provide differential backup, as an additional advantage, the steps performable at the server terminal for providing differential backup of the data stored at the user terminal may include the step of generating a recipe file using longest common subsequence method (29). The additional step i.e. step 29 can be performed when any client chunk is received by the server terminal in step 28. The recipe file is generated in step 29 based on a client chunk and its corresponding server chunk. The recipe file, if any generated in step 29 can be stored in step 30 at the server terminal. After generation of the recipe file, the client chunk and its corresponding server chunk are re-arranged to facilitate further processing. This would not only reduce the amount of space occupied at the server terminal but also assist in providing other additional benefits including but not limited to version tracking which would be described in detail below.

For the purpose of simplicity, the server repository can be understood as containing files and there recipes of all the users in a compressed form. If any backup file is not found on the client repository the same is retrieved from the server.

As multiple users may access a single file and modify, it would be advantageous to store the recipe files with an indication the user who has generated the recipe file. Also as a single user can generate multiple versions of the same file or in other words, modify the same file on different time periods, it may be beneficial to store the recipe files with an indication of the time of storage or in other words, the time of last modification as mentioned above.

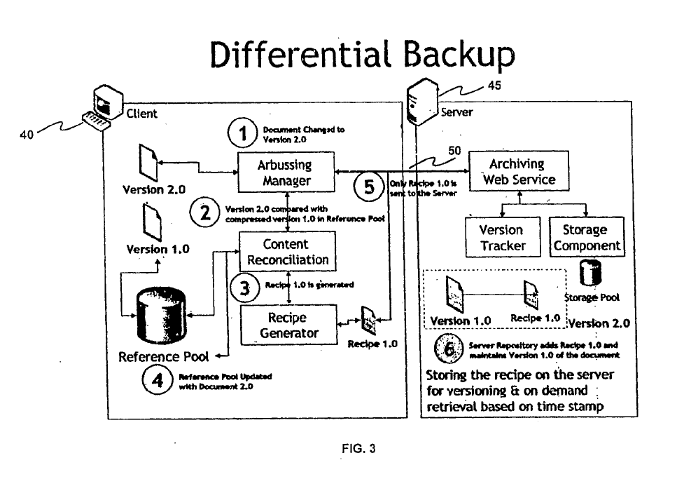

In order to enable a person skilled in the art to perform the method of the present invention, the system is illustrated in FIG. 3, wherein the client terminal is indicated by the reference number 40 and the server terminal is represented by the reference number 45 and the communication link is represented by the reference link 50. It should however be understood that instead of only one client terminal, the system in reality may contain plurality of client terminals which may interact with a single server terminal.

### Detailed Description of the Differential Backup Method:

When client chooses file or files to back up, the file is searched on the client repository. If the file is found, the recipe is generated using LCS. The generated recipe is compressed on the client side and stored in client repository which maintains the different versions of the file. Also the compressed recipe is sent to the server which maintains the version of the file, as well.

If the file is not found, then the file is compressed and saved in the client repository. In case if the repository is found to be full, then Life time management service is called in to free some space. Once the file is stored in the client repository, it is then checked with the server and the compressed file is saved on to the server, if it does not exist. But if the file exists on the server, then the steps followed are as below:
1. The uncompressed file is broken into chunks and check sum is calculated and sent to the server.
2. Check sum of the client chunk is compared with the check sum of the server chunk.
3. If the check sum of the client chunk comes out to be different from that of the server, then the chunk is sent to the server, else the chunk is not sent from the client. This is called Rolling Check Sum.
4. Using LCS (Longest Common Subsequence) between the server and the client chunk, recipe is generated.
5. The recipe is now applied to the server chunk. The recipe also determines the type of orientation that would have taken place on client file i.e. Insert, Delete etc.
6. After applying the recipe on the server chunk, the file chunks get rearranged. This is very important for remaining operations on other chunks.
7. Now check sum is performed on the next chunk and the same process continues.
8. So, the old version of the file remains saved on the server and new file version, which is formed is discarded. Only the recipe of the new version will be saved on the server in compressed form.

Whenever a file is backed for the first time, the compressed copy of that file is saved in the reference pool. Before insertion of any file in the reference pool, the file rank is calculated and inserted in the Reference Pool Index based on its rank. The file will stay in the reference pool for a longer period of time if the rank is higher. The file has higher chances of deletion from the reference pool if the rank is lower.

Subsequently when a user modifies a backed up file, the file is backed up again on the server. This time before backing up the file, the file is looked into the reference pool for its previous backed up version. If the file is found in the reference pool, it is uncompressed and is then compared with the version which is about to be backed up. The comparison is done using LCS method. This comparison generates a recipe which contains the difference between the latest and the previous version of the same file.

This recipe is sent on the server in chunks along with the checksum of the previous file. On receipt of the first chunk the server calculates the checksum of the file present on the server. If the checksums match, it means that the server file was not modified from any other source after previous backup. The recipe chunk is stored on the server and a success messages is given back to the client. The client continues to send the recipe chunks to the server until the complete recipe is transferred. The server then stores the recipe along with the previous version of the file. This way the server maintains the first version of the file and subsequent recipes on server repository. This way of storing recipes helps in providing forward versioning.

If the checksum of the file in server repository and the checksum sent by the client do not match, it is perceived that the server file was modified from some other source and hence the recipe generated by the client is not valid. The server send an error message back to the client for this scenario and client deletes the file from the reference pool. This file is then transferred completely on the server and not backed up differentially.

### Version Tracking Using Differential Backup

One of the main advantages of differential backup is versioning support during backup. Since multiple recipes can be stored on the server, this provides a mechanism to store multiple versions of a file without storing actual versions. This saves a lot of storage on the server. There are two types of versioning support possible, Forward and Backward Versioning.

### Forward Versioning

This means that the oldest version of the document is readily available and the subsequent versions are calculated on demand. E.g. if a file with original version V1.0 is backed up on the server and subsequently recipe R1.0 (Difference between version V1.0 and V2.0) is stored on the server. In case the user demands for V2.0 of the file, then R1.0 is applied on V1.0 to produce V2.0 of the file.

### Backward Versioning

This technique ensures that the latest version of the document is readily available and previous versions are calculated on demand. E.g. if a file with original version V1.0 is backed up on the server and subsequently recipe R1.0 (Difference between version V1.0 and V2.0) is transferred on the server, the R1.0 is applied on the V1.0 to produce V2.0 at the time of backup. Then a reverse recipe to create V1.0 from V2.0 is calculated and stored on the server. The original version of the document V1.0 is then deleted.

### Longest Common Subsequence Method:

For complete details on the longest-common-subsequence method, the following web-site may be referred, the contents of which are incorporated herein as reference. http://www.csse.monash.edu.au/˜lloyd/tildeStrings/Alignment/86.IPL.html

It will be appreciated that method steps of the invention described herein may be implemented using one or more conventional processors and unique stored program instructions that control the one or more processors to implement, in conjunction with certain non-processor circuits, some, most, or all of the functions described herein. Alternatively, some or all method steps could be implemented by a state machine that has no stored program instructions or in one or more application specific integrated circuits (ASICs), in which each method or some combinations of certain of the method steps are implemented as custom logic. Of course, a combination of the two approaches could be used. Thus, method and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Benefits of using Differential Algorithm:
1. Saves Network Bandwidth.
2. Ensures no data is lost while transmission.
3. Makes uploading and retrieval of data very fast.
4. Saves lot of storage space at the server terminal and also at the user terminal.

The foregoing detailed description has described only a few of the many possible implementations of the present invention. Thus, the detailed description is given only by way of illustration and nothing contained in this section should be construed to limit the scope of the invention. The claims are limited only by the following claims, including the equivalents thereof.

We claim:

1. A method for taking differential backup of a file present at a client terminal, said method comprising the steps of:
(a) receiving the file to be backed-up from the client terminal;
(b) determining presence of an entry corresponding to the file thus received at a client repository;
characterized in that:
(c) if the client repository does not contain an entry corresponding to the file, the method comprising the sub-steps of:
i. compressing the file thus received in step (a),
ii. updating the client repository to create an entry of the file, and
iii. transmitting the file thus received in step (a) and/or the compressed file thus generated in step (i) to a remote location; or
(d) if the client repository contains an entry corresponding to the file, the method comprising the sub-steps of:
i. generating a recipe file using longest common subsequence method,
ii. updating the client repository to create an entry of the recipe file, and
iii. transmitting the recipe file to the remote location.

2. The method as claimed in claim 1, wherein steps (a) to (d) are performed at the client terminal.

3. The method as claimed in claim 1, wherein the file compressed in sub-step (i) of step (c) is stored at the client terminal.

4. The method as claimed in claim 1 wherein in sub-step (iii) of step (c), the file received in step (a) is transmitted to the remote location.

5. The method as claimed in claim 4, wherein after transmitting the file received in step (a), step (c) optionally comprises the step of deleting the file thus received in step (a) from the client terminal.

6. The method as claimed in claim 1, wherein the recipe file generated in sub-step (i) of step (d) is optionally in a compressed form.

7. The method as claimed in claim 6, wherein after transmitting the compressed form of the recipe file, step (d) optionally comprises the step of deleting the recipe file thus generated from the client terminal.

8. A method for taking differential backup of a file present at a client terminal upon a server terminal, said method comprising the steps of:
(a) receiving detail of the file to be backed-up from the client terminal;
(b) determining presence of an entry corresponding to the file details thus received from the client terminal at a server repository;
characterized in that:
(c) if the server repository does not contain an entry corresponding to the file details, the method comprising the sub-steps of:
i. receiving the file from the client terminal,
ii. storing the file thus received at the server terminal; and
iii. updating the server repository to create an entry of the file, or
(d) if the server repository contains an entry corresponding to the file details, the method comprising the sub-steps of:
i. receiving at least one client check sum from the client terminal;
ii. comparing each of the at least one client check sum with corresponding at least one server check sum to generate mismatched check sum; and
iii. in respect of each mismatched check sum, receiving a client chunk from the client terminal, storing the client chunk(s) thus received at the server terminal and updating the server repository to create entry(ies) of the client chunk(s) thus stored.

9. The method as claimed in claim 8, wherein steps (a) to (d) are performed at the server terminal.

10. The method as claimed in claim 8, wherein the file thus received from the client terminal in sub-step (i) of step (c) is optionally in a compressed form.

11. The method as claimed in claim 8, wherein the client check sum is generated by breaking the file to be backed up present at the client terminal into plurality of client chunks and calculating client check sum in respect of each client chunk.

12. The method as claimed in claim 8, wherein the server check sum is generated by breaking the file present at the server terminal into plurality of server chunks and calculating server client check sum in respect of each server chunk.

13. The method as claimed in any of claim 11 or 12, wherein the file which is broken is in un-compressed form.

14. The method as claimed in 8, wherein if any client chunk is received by the server in sub-step (iii) of step (d), the method optionally comprises generating a recipe file using longest common subsequence method.

15. The method as claimed in claim 14, wherein a recipe file is generated based on a client chunk and its corresponding server chunk.

16. The method as claimed in claim 14, wherein the recipe file thus generated is stored at the server terminal.

17. The method as claimed in claim 15, wherein after generation of the recipe file, the client chunk and its corresponding server chunk are re-arranged to facilitate further processing.
